(19) United States
(12) Patent Application Publication
(10) Pub. No.: US 2017/0372089 A1
(43) Pub. Date: Dec. 28, 2017

(54) METHOD AND SYSTEM FOR DYNAMIC VIRTUAL PORTIONING OF CONTENT

(71) Applicant: Tata Consultancy Service Limited, Mumbai (IN)

(72) Inventor: Sunil Kumar KOPPARAPU, Thane (IN)

(73) Assignee: Tata Consultancy Services Limited, Mumbai (IN)

(21) Appl. No.: 15/473,083

(22) Filed: Mar. 29, 2017

(30) Foreign Application Priority Data
Jun. 22, 2016 (IN) 201621021499

(51) Int. Cl. G06F 21/62; H04W 8/18; G06F 17/30; H04W 88/02

(52) U.S. Cl. CPC G06F 21/6218; G06F 17/3074; H04W 8/183; G06F 17/30241; G06F 17/30244; H04W 88/02

(57) ABSTRACT

A system and method for virtual portioning of content on a mobile device, comprising assigning each content of the plurality of content stored on the mobile device one or more tags based on a predefined environment information, identifying, a surrounding environment surrounding the mobile device in real time, associating a tag with the identified surrounding environment wherein the tag is one of the one or more tags assigned to each of the plurality of content; and controlling access to the plurality of content stored on the mobile device wherein access is granted to a portion of the content when at least one of the one or more tags assigned to each of the portion of the content matches the tag associated with the identified environment.

### PRIORITY CLAIM

This U.S. patent application claims priority under 35 U.S.C. §119 to: India Application No. 201621021499, filed on Jun. 22, 2016. The entire contents of the aforementioned application are incorporated herein by reference.

### TECHNICAL FIELD

This disclosure relates generally to virtual portioning, and more particularly to a method and system for virtual portioning of content stored on a mobile device.

### BACKGROUND

With the reduction in strict distinction between work place environment and home environment use of multiple devices has become increasingly prevalent. BYOD (bring your own device) is increasingly becoming popular with the blur in strict work place and home. Carrying two or more devices, one for work and another for personal use is able to create two islands of storage of information which do not overlap.

However there is a pain in carrying two devices, one for work and another for personal use. Similarly one may have to carry multiple devices based on the various environment that a user visits, where he uses or is authorized to use only part information on a device.

The current state of the art does not provide a method and system for dynamic virtual portioning of content on a single mobile device such that only some content on the same mobile device may be used at only some locations based on the identified environment at the different locations.

Therefore there is a need for a system that allows a user to carry a single device, however with the express ability to create virtual spaces based on the identified environment, such that only relevant content is visible and hence accessible based on the environment.

### SUMMARY

Before the present methods, systems, and hardware enablement are described, it is to be understood that this invention is not limited to the particular systems, and methodologies described, as there can be multiple possible embodiments of the present invention which are not expressly illustrated in the present disclosure. It is also to be understood that the terminology used in the description is for the purpose of describing the particular versions or embodiments only, and is not intended to limit the scope of the present invention which will be limited only by the appended claims.

The present application provides a method and system for virtual portioning of content on a mobile device.

The present application provides a computer implemented method for virtual portioning of content on a mobile device, in an aspect the method comprises processor implemented steps such that, each content of the plurality of content stored on the mobile device is assigned one or more tags using a content tagging module (210). In an embodiment the one or more tags are based on a predefined environment information. The method further comprises identifying, using an environment identification module (212), a surrounding environment surrounding the mobile device in real time. In an embodiment of the method disclosed identifying comprises capturing, a plurality of parameters using at least one sensors operatively coupled with the mobile device, extracting, a plurality of feature vectors from the captured plurality of parameters using a feature extraction technique, and identifying, the surrounding environment based on the extracted plurality of feature vector and predefined environment information. The method further comprises associating a tag with the identified surrounding environment using the environment identification module (212). In an embodiment the tag is one of the one or more tags; and controlling access to the plurality of content stored on the mobile device wherein access is granted to a portion of the content when at least one of the one or mere tags assigned to each of the portion of the content matches the tag associated with the identified environment, using an access control module (214).

In another aspect, the present application provides a system (102), comprising a processor (202), a memory (206) coupled to said processor wherein the system further comprises a content tagging module (210) configured to assigning, each content of the plurality of content stored on the mobile device, one or more tags, wherein the one or more tags are based on a predefined environment information. The system (102) further comprises an environment identifier module (212) configured to identify a surrounding environment, surrounding the mobile device in real time. In an embodiment identification comprises steps of capturing, a plurality of parameters using at least one sensors operatively coupled with the mobile device, extracting, a plurality of feature vectors from the captured plurality of parameters using various feature extraction techniques, and identifying, the surrounding environment based on the extracted plurality of feature vector and predefined environment information. The system (102) further comprises the environment identification module (212) configured to associate a tag with the identified surrounding environment, wherein the tag is one out of the one or more tags; and an access control module (214) configured to control access to the content stored on the mobile device, wherein access is granted to a portion of the content when at least one of the one or more tags assigned to each of the portion of the content, matches the tag associated with the identified environment.

### BRIEF DESCRIPTION OF THE DRAWINGS

The foregoing summary, as well as the following detailed description of preferred embodiments, are better understood when read in conjunction with the appended drawings. For the purpose of illustrating the invention, there is shown in the drawings exemplary constructions of the invention; however, the invention is not limited to the specific methods and system disclosed. In the drawings:

FIG. 1: illustrates a network implementation of a system for virtual portioning of content on a mobile device, in accordance with an embodiment of the present subject matter;

FIG. 2: shows block diagrams illustrating the system for virtual portioning of content on a mobile device, in accordance with an embodiment of the present subject matter;

FIG. 3: shows a flow chart illustrating the method for virtual portioning of content on a mobile device in accordance with an embodiment of the present subject matter; and

FIG. 4: shows a flow chart illustrating the steps for identification of a surrounding environment in real time, in accordance with an embodiment of the present subject matter.

### DETAILED DESCRIPTION

Some embodiments of this invention, illustrating all its features, will now be discussed in detail.

The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

The disclosed embodiments are merely exemplary of the invention, which may be embodied in various forms.

The elements illustrated in the Figures inter-operate as explained in more detail below. Before setting forth the detailed explanation, however, it is noted that all of the discussion below, regardless of the particular implementation being described, is exemplary in nature, rather than limiting. For example, although selected aspects, features, or components of the implementations are depicted as being stored in memories, all or part of the systems and methods consistent with the attrition warning system and method may be stored on, distributed across, or read from other machine-readable media.

The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), plurality of input units, and plurality of output devices. Program code may be applied to input entered using any of the plurality of input units to perform the functions described and to generate an output displayed upon any of the plurality of output devices.

Each computer program within the scope of the claims below may be implemented in any programming language, such as assembly language, machine language, a high-level procedural programming language, or an object-oriented programming language. The programming language may, for example, be a compiled or interpreted programming language. Each such computer program may be implemented in a computer program product tangibly embodied in a machine-readable storage device for execution by a computer processor.

Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

Any data disclosed herein may be implemented, for example, in one or more data structures tangibly stored on a non-transitory computer-readable medium. Embodiments of the invention may store such data in such data structure(s) and read such data from such data structure(s).

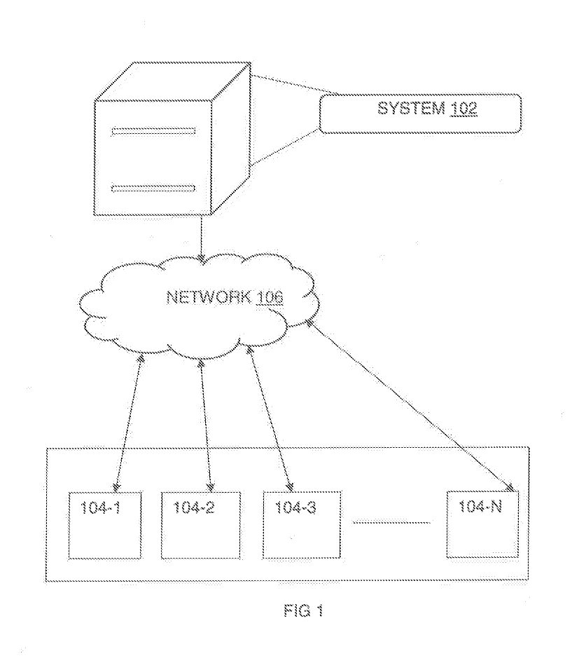

The present application provides a computer implemented method and system for virtual portioning of content stored on a mobile device. Referring now to FIG. 1, a network implementation 100 of a system 102 for virtual portioning of content on a mobile device is illustrated, in accordance with an embodiment of the present subject matter. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

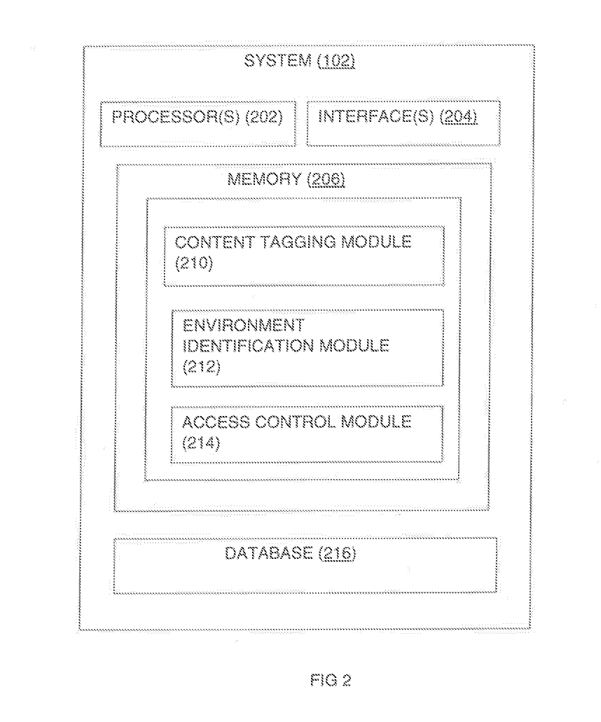

In one embodiment the present invention, referring to FIG. 2, a detailed working of the various components of the system 102 is illustrated.

In one aspect the system 102 comprises a database 216 wherein the database 216 comprises a predefined list of environment and related predefined environment information for the each of the environment in the predefined list of environment. The system may further be configured such that the database may be able to store more information related to an environment based on user/administer input.

In one embodiment of the invention, referring to FIG. 2 a system (102) for virtual portioning of a plurality of content stored on a mobile device is disclosed. The system (102) comprises a content tagging module (210) which is configured to assign one or more tag to each content of the plurality of content stored on the mobile device. In an embodiment the one or more tags are assigned based on predefined environment information. In one example where the environment may be “Work” and “Home” and content may be files stored on the mobile device, the files that are accessed only in “Home” environment are assigned the tag “H”, files that are accessed only in “Work” are assigned the tag “W” and files that are accessible in both “Home” and “Work” environment are assigned the tag “X”. Therefore in the instant example the plurality of tags comprises “H” “W” and “X” and the based on environment information of “Work” and “Home”. In one embodiment the environment information may be predefined and stored by the user or a system administrator. In another embodiment the environment information may be stored and updated over the network.

The system 102 further comprises an environment identification module (212) configured to identify a surrounding environment in real time. In an embodiment surrounding environment may be identified as one of the predefined environment based on predefined environment information. In an embodiment the identification of the surrounding environment comprises the steps of capturing, a plurality of parameters using at least one sensors operatively coupled with the mobile device, extracting, a plurality of feature vectors from the captured plurality of parameters using a feature extraction technique, and identifying, the surrounding environment based on the extracted plurality of feature vector and pre-defined environment information. In an embodiment the captured parameters may be one of an image, a GPS coordinates and a sound from the environment and the duration of the sound, where these parameters are captured by a camera, a GPS device and a microphone which may be operatively coupled with the mobile device. Further in an embodiment the environment detection module (214) is configured to extract a plurality of feature vectors from each of the plurality of parameters by processing the plurality of parameters using at least one feature extraction technique for one or more of the plurality of parameters.

In an embodiment when the environment identification module (212) is unable to identify a surrounding environment, i.e. no surrounding environment is detected based on the extracted plurality of feature vectors and predefined environment information, the environment detection module is further configured to prompt a list of predefined environment to the user wherein the user may select one of the environment. Further in another embodiment the user selection along with the parameters captured at the location may be stored in the database (216) along with the predefined environment information. In another embodiment storing may require confirmation from a device administrator.

Referring to FIG. 2 the environment tagging module is further configured to associate a tag with the identified surrounding environment. In an embodiment the associated tag is one of the one or more tag assigned to the each of the plurality of content. Further the system 102 comprises an access control module configured to control access to the plurality of content stored on the mobile device wherein access is granted to a portion of the content when at least one of the one or more tags assigned to each of the portion of the content matched the tag associated with the identified surrounding environment. In an example where the mobile device stores a plurality of files the access control module allows a user to access only those files which have at least one tag matching the tag associated with the surrounding environment by the environment identification module (212).

In an embodiment when the environment identification module (212) is unable to identify a surrounding environment and the user selects an environment in response to the prompting of a predefined list of environment, the access control module (214) may be configured to provide access to the portion of content based on the tag pre-associated with the user selected environment. In an embodiment of the subject matter disclosed herein tag maybe pre-associated the selected environment based on the predefined environment information.

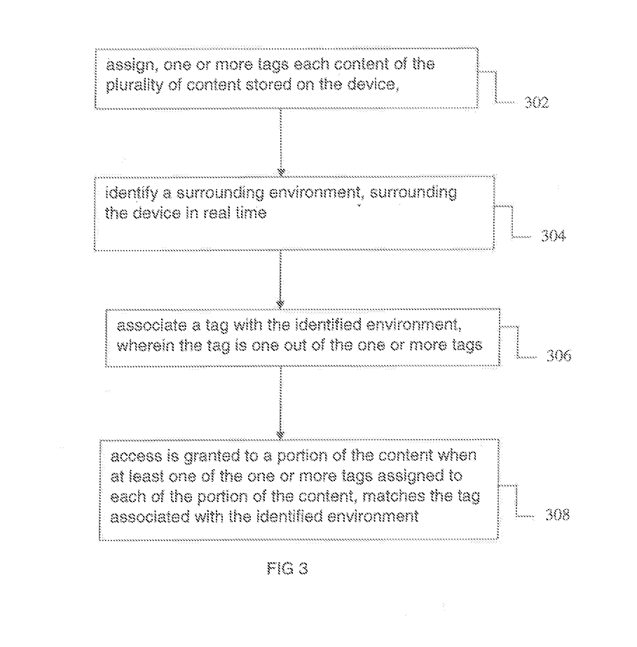

Referring to FIG. 3 the method for virtual portioning of content on a mobile device in accordance with an embodiment of the present subject matter is shown. The process for virtual portioning of a plurality of content stored on a mobile device starts at the step 302 where each of the plurality of content stored on a mobile device is assigned one or more tags. In an embodiment the one or more tags are based on predefined environment information.

The method further comprises as illustrated at the step 304 identifying a surrounding environment in real time wherein the surrounding environment refers to the environment surrounding the mobile device. In an embodiment when no surrounding environment can be identified, the environment detection module is further configured to prompt a list of predefined environment to the user wherein the user may select one of the environment. Further in another embodiment the user selection along with the parameters captured at the location may be stored in a database along with the predefined environment information.

At the step 306 a tag is associated with the identified surrounding environment. In an embodiment the tag is one of the one or more tags associated with each of the plurality of content.

Finally at the step 308, access is granted to a user such that when access is granted to a portion of the plurality of content when at least one of the one or more tags assigned to each of the portion of the plurality of content, matches the tag associated with the identified environment.

In an embodiment when the surrounding environment cannot be identified and the user selects an environment in response to the prompting of a predefined list of environment, access may be provided to the portion of content based on the tag associated with the user selected environment. In an embodiment of the subject matter disclosed herein a tag maybe pre-associated the selected environment based on the predefined environment information.

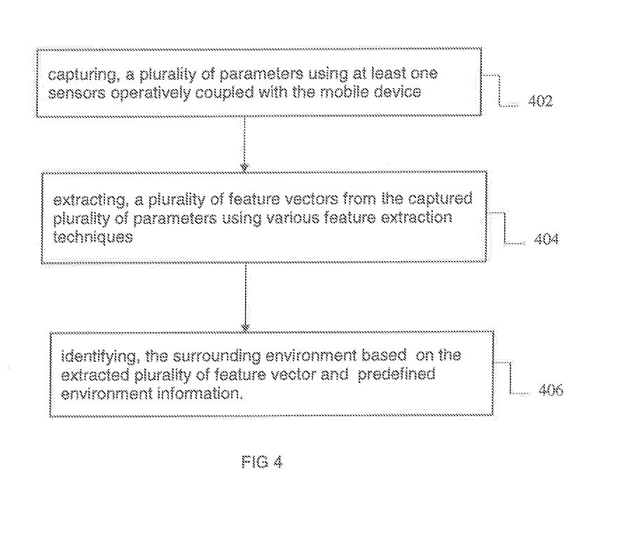

Referring now to FIG. 4 the steps involved in the identification of a surrounding environment are illustrated by means of a flowchart. The process of identification, as shown in FIG. 4 is explained in the following paragraphs.

At the step 402 the method comprises capturing, a plurality of parameters using at least one sensors operatively coupled with the mobile device. In one aspect the sensors may comprise one or more of a camera, a GPS and a microphone capturing an image, a GPS coordinates/latitude, longitude, altitude information and a sound and duration of the sound in the surrounding of the mobile device respectively.

At the step 404 the captured plurality of parameters are processed to extract a plurality of feature vectors. In one embodiment a plurality of feature extraction techniques may be employed to extract the plurality of feature vectors from the plurality of parameters.

The identification is completed at the step 406 the extracted plurality of feature vectors may be used in combination with the predefined environment information to identify the surrounding environment.

The following paragraphs contain exemplary embodiments for meant for the sole purpose of explaining the proposed invention and shall not be construed as limiting the scope of the invention claimed in the instant application.

In the instant exemplary embodiment of the disclosed invention it is assumed that a mobile device is used in “work” and “home” environment. Further for the instant example it is assumed, that the device is used in either home-environment or work-environment and every information stored in the device is in form of a file where each of the filed stored on the mobile device are assigned a tag by a content tagging module. The proposed system then automatically identifies the environment based on several parameters and then allows visibility of only those files that are associated with the environment tag.

In the instant example, if wA, wB, wC, wD, wE have the tag for “work” environment and h1, h2, h3, h4, h5 are the files that have the tag are the files that have the tag for “home” environment, and xX, xY, xZ are the files with tags for the both “home” and “work” environment. In the instant example the user of the mobile device is in home environment, then he can only see the files with tags for “home” environment and both environment i.e. the user should be able to see the files h1, h2, h3, h4, h5 and xX, xY, xZ. Similarly when the user is in “work” environment, i.e. the surrounding environment is “work” environment then the user can see only the files that have the tags for “work” environment and both environment, i.e. the user should be able to access files, wA, wB, wC, wD, wE and xX, xY, xZ.

According to this example, the environment identification module (214) uses onboard sensors on the device to reliably identify the environment. The sensors may include a GPS which identifies the latitude, longitude, altitude, “g1”, “g2”, “g3”; a camera captures the images of the environment in which the device is and generates say a feature “c1” and a microphone captures the ambient audio of the environment it is in, “a1” along with the time for the which the audio is present “t”.

In an aspect one or more feature extraction techniques may be implemented to extract the values of “g1”, “g2”, “g3” “c1” “a1” and “t” such that a probability of identification of a surrounding environment being a “work” or “home” environment may be determined. Further in another embodiment according to the present example the identified environment may be tagged as “work” or “home” and the access control module (216) may then provide access to such files which may be accessed in the identified environment.

In the event that an environment cannot be identified a list of predefined environments i.e. “Home” and “Work” may be prompted to a user who may select either one of the environment and access files according to the selection.

Further in an embodiment the selection along with the parameters collected by the sensors may be stored in a database as part of the predefined environment information such that this information may be used in the future for identifying the environment. Further in another embodiment the selection and the associated parameter information may be sent to an administrator who may verify and add this data into the database.

The foregoing example uses two environment, and a mobile device with an exact set of sensors and content comprising only of files. However the example may not be seen as limiting the scope of the current invention vis-a-vis said limitations and it may be understood by a person skilled in the art that the number of environments, the number and types of sensors and the type of content may not be limited to that presented in the example but the disclosed system and method may be implemented in various different scenarios and therefore the scope of the application may be construed only by means of the following claims.

What is clamed is:

1. A method for virtual portioning of a plurality of content stored on a mobile device, said method comprising processor implemented steps of:
assigning, each content of the plurality of content stored on the mobile device, one or more tags using a content tagging module (210), wherein the one or more tags are based on a predefined environment information;
identifying, using an environment identification module (212), a surrounding environment surrounding the mobile device in real time, wherein identification comprises:
capturing, a plurality of parameters using at least one sensors operatively coupled with the mobile device,
extracting, a plurality of feature vectors from the captured plurality of parameters using a feature extraction technique, and
identifying, the surrounding environment based on the extracted plurality of feature vector and the predefined environment information;
associating a tag with the identified surrounding environment using the environment identification module (212) wherein the tag is one of the one or more tags assigned to each of plurality of content; and
controlling access to the plurality of content stored on the mobile device wherein access is granted to a portion of the plurality of content when at least one of the one or more tags assigned to each of the portion of the plurality of content matches the tag associated with the identified environment, using an access control module (214).

2. The method according to claim 1 wherein at least one sensor is selected from a group comprising of a camera, a GPS mobile device and a microphone and the corresponding captured plurality of parameters are image of the environment, latitude, longitude and altitude location of the environment and ambient audio of the environment along with time of the sound respectively.

3. The method according to claim 1 wherein the plurality of feature vectors are extracted by processing each of the plurality of parameters to identify the surrounding environment wherein the environment is identified by matching the plurality of feature vectors with the predefined environment information.

4. The method according to claim 1 wherein when no surrounding environment can be identified using the plurality of feature vectors by the environment identification module (212), identifying further comprises:
displaying, by the environment identification module (212), a list of predefined environments to the user; and
allowing access, by the access control module (214) to the portion of the content based on the tag associated with a selected environment from the list of predefined environment.

5. A system (102) for virtual portioning of a plurality of content stored on a mobile device, comprising a processor (202), a memory (206) coupled to said processor the system comprising:
a content tagging module (210) configured to assigning, each content of the plurality of content stored on the mobile device, one or more tags, wherein the one or more tags are based on a predefined environment information;
an environment identifier module (212) configured to identify a surrounding environment, surrounding the mobile device in real time, wherein identification comprises:
capturing, a plurality of parameters using at least one sensors operatively coupled with the mobile device,
extracting, a plurality of feature vectors from the captured plurality of parameters using various feature extraction techniques, and
identifying, the surrounding environment based on the extracted plurality of feature vector and surrounding environment information;
the environment identification module (212) configured to associate a tag with the identified surrounding environment, wherein the tag is one out of the one or more tags assigned to each of the plurality of content; and
an access control module (214) configured to control access to the content stored on the mobile device, wherein access is granted to a portion of the plurality of content when at least one of the one or more tags assigned to each of the portion of the plurality of content, matches the tag associated with the identified environment.

6. The system (102) according to claim 5 wherein at least one sensor is selected from a group comprising of a camera, a GPS mobile device and a microphone and the corresponding captured plurality of parameters are image of the environment, latitude, longitude and altitude location of the environment and ambient audio of the environment along with time of the sound respectively.

7. The system (102) according to claim 5 wherein the plurality of feature vectors are extracted by processing each of the plurality of parameters to identify the surrounding environment wherein the environment is identified by matching the plurality of feature vectors with the predefined environment information.

8. The system (102) according to claim 5 wherein when no surrounding environment can be identified using the plurality of feature vectors identification further comprises
the environment identification module (214) is configured to display, a list of predefined environments to the user: and
the access control module (216) is configured to allow, access to the portion of the content based on the tag associated with a selected environment from the list of predefined environment.

9. One or more non-transitory machine readable information storage mediums comprising one or more instructions which when executed by one or more hardware processors causes the one or more hardware processor to perform a method for virtual portioning of a plurality of content stored on a mobile device, said method comprising:
assigning, each content of the plurality of content stored on the mobile device, one or more tags using a content tagging module (210), wherein the one or more tags are based on a predefined environment information;
identifying, using an environment identification module (212), a surrounding environment surrounding the mobile device in real time, wherein identification comprises:
capturing, a plurality of parameters using at least one sensors operatively coupled with the mobile device,
extracting, a plurality of feature vectors from the captured plurality of parameters using a feature extraction technique, and
identifying, the surrounding environment based on the extracted plurality of feature vector and the predefined environment information;
associating a tag with the identified surrounding environment using the environment identification module (212) wherein the tag is one of the one or more tags assigned to each of plurality of content; and
controlling access to the plurality of content stored on the mobile device wherein access is granted to a portion of the plurality of content when at least one of the one or more tags assigned to each of the portion of the plurality of content matches the tag associated with the identified environment, using an access control module (214).

10. The one or more non-transitory machine readable information storage mediums of claim 9, wherein at least one sensor is selected from a group comprising of a camera, a GPS mobile device and a microphone and the corresponding captured plurality of parameters are image of the environment, latitude, longitude and altitude location of the environment and ambient audio of the environment along with time of the sound respectively.

11. The one or more non-transitory machine readable information storage mediums of claim 9, wherein the plurality of feature vectors are extracted by processing each of the plurality of parameters to identify the surrounding environment wherein the environment is identified by matching the plurality of feature vectors with the predefined environment information.

12. The one or more non-transitory machine readable information storage mediums of claim 9, wherein when no surrounding environment can be identified using the plurality of feature vectors by the environment identification module (212), identifying further comprises:
displaying, by the environment identification module (212), a list of predefined environments to the user; and
allowing access, by the access control module (214) to the portion of the content based on the tag associated with a selected environment from the list of predefined environment.
